(19) United States
(12) Patent Application Publication
(10) Pub. No.: US 2017/0225660 A1
(43) Pub. Date: Aug. 10, 2017

(54) OPTICAL DETECTION SYSTEM FOR A MOTOR VEHICLE, AND DEVICE FOR CLEANING SUCH A SYSTEM

(71) Applicant: Valeo Systèmes d'Essuyage, Le Mesnil Saint Denis (FR)

(72) Inventors: Marcel Trebouet, Chavenay (FR); Giuseppe Grasso, Le Breuil sur Couze (FR); Grégory Kolanowski, Siaugues-Saint-Romain (FR)

(73) Assignee: Valeo Systèmes d'Essuyage, Le Mesnil Saint Denis (FR)

(21) Appl. No.: 15/422,541

(22) Filed: Feb. 2, 2017

(30) Foreign Application Priority Data
Feb. 5, 2016 (FR) 1650942

(51) Int. Cl. B60S 1/52; B60S 1/50; A47L 7/00; B60S 1/56; G01S 17/93; G01S 7/497

(52) U.S. Cl. CPC B60S 1/52; G01S 17/93; G01S 7/497; A47L 7/0023; A47L 7/0076; A47L 7/0009; B60S 1/56; B60S 1/50; G01S 2007/4977

(57) ABSTRACT

The invention relates to a device for cleaning an optical sensor (2) of an optical detection system of a motor vehicle, which comprises spray means (4) for spraying a cleaning liquid onto an exterior surface (20) of this optical sensor (2). The device comprises suction means (7) of which a chamber (5) opens onto at least a portion of the periphery of this optical sensor (2).

The present invention relates to the field of driving aid devices and, more particularly, to the field of optical assemblies used for that purpose, such as image capturing means, particularly cameras. The invention relates more particularly to the devices for cleaning an optical sensor of an optical detection system for a vehicle.

An optical detection system is a name given to any system comprising optical sensors, such as cameras, laser sensors (commonly referred to as LIDAR o sensors) or other sensors based on the emission and/or detection of light in the spectrum visible or invisible to man, particularly in the infrared.

Such optical detection systems are being fitted to an increasing number of motor vehicles in order to aid the driver of the vehicle in certain driving situations of which one well known situation is assistance with parking. For this aid to be as effective as possible, the data supplied by the optical detection system need to be of the best possible quality, and it is therefore absolutely essential to have optics that are dean in order to perform this data acquisition. In order to achieve that, a device for cleaning an optical sensor, for example a lens of a camera, may be commanded to inject cleaning fluid onto the said lens just before the image is captured. These devices must not impede the image capture optics when these are in operation, and need to be as compact as possible in order to conform to vehicle space availability constraints. Moreover, in the event that the cleaning liquid sprayed onto such a lens in order to expel dirt is a liquid, it is advantageous for this lens to be dried as quickly as possible in order to avoid any risk of the image being contaminated by potential traces that such a liquid may leave (drops, runs, etc), For that, it is known practice for a flow of air to be sprayed onto the lens, after the cleaning liquid, to allow this lens to be rid of the cleaning liquid and of the dirt that this liquid then carries with it. That, however, imposes the creation and management of two fluid transport circuits, one for the cleaning liquid and the other for the drying air. Cleaning devices in which the cleaning liquid distribution circuit and the drying air distribution circuit comprise portions in common and/or have a form in which one is fabricated with the other are known, but mechanically achieving these presents a degree of complexity, as does managing them within the cleaning process.

It is an object of the present invention to simplify such a cleaning device while at the same time maintaining its performance, and to propose an alternative solution for removing the cleaning liquid and dirt that the latter may carry with it, and for the cleaning process itself.

To this end, one subject of the invention is a device for cleaning an optical sensor of an optical detection system of a motor vehicle, which comprises spray means for spraying a cleaning liquid onto an exterior surface of this optical sensor, characterized in that it comprises suction means of which a chamber opens onto at least a portion of the periphery of this optical sensor.

According to a preferred but nonexclusive embodiment of the invention, this chamber opens onto a portion of the periphery of the optical sensor substantially on the opposite side, with respect to the centre of the optical sensor, from the region from which the cleaning liquid is sprayed onto the exterior surface of the optical sensor. According to various embodiments, the chamber opens at one or more zones of the periphery of the optical sensor or opens over the entire perimeter of the optical sensor to form an annular opening which extends over the entire periphery of the optical sensor.

In a known way, the optical detection system is inserted into a receiving casing, such that the exterior surface of its optical sensor lies flush with this casing and allows data acquisition with the widest possible angle. For this, the optical sensor is conventionally housed inside a collar, advantageously made from a material that offers a certain degree of elasticity in order to absorb mechanical stresses that may be applied to the optical sensor as a result of potential deformations and/or vibrations of the casing or potential impacts therewith. This collar also has a sealing function, preventing potential dirt or traces of rainwater from entering the casing that houses the optical detection system. Advantageously, the chamber of the cleaning device according to the invention is arranged in this collar that houses the optical sensor and opens to the exterior surface of this collar. The optical sensor is fitted tightly inside the collar, and the chamber is hollowed into the thickness of this collar, between an interior edge placed in contact with the exterior peripheral edge of the optical sensor, and an exterior edge of the said collar,

According to another feature, the chamber of the cleaning device according to the invention comprises an elastic sealing lip able to move between a closed position in which it prevents any passage of liquid from the exterior, and notably from the exterior surface of the optical sensor, to the inside of the chamber, and an open position in which it allows the cleaning liquid, originally deposited on the optical sensor to pass towards the inside of the chamber. This elastic sealing lip is advantageously given the ability to move from one position to the other under the effect of the actuation of suction means designed to evacuate the chamber arranged around the optical sensor. These suction means, which may notably comprise a pump, are configured to discharge the sucked-up liquid into a storage reservoir to supply the means of spraying the optical sensor with cleaning liquid. The sealing lip is configured to adopt the open position when the pump is actuated and to return to the original position, namely the closed position, when the pump is switched off.

In a known way, the cleaning liquid is sprayed onto the exterior surface of the optical sensor through a distribution orifice placed at one end of a distribution nozzle of such a cleaning device, this distribution nozzle itself being connected, by appropriate conveying means, to the cleaning liquid storage reservoir.

According to various embodiments, the distribution nozzle may have a position that is fixed with respect to the exterior surface of the optical sensor, or may be capable of moving between a deployed position, in which its distribution orifice is situated close to the exterior surface of this optical sensor so that it can spray the cleaning liquid thereonto, and a retracted position in which the distribution orifice is set back from the exterior surface of the optical sensor, notably so as not to impede data acquisition. Whatever the embodiment adopted for this distribution nozzle, the cleaning device according to the invention also comprises means for sucking up the cleaning liquid.

Furthermore, according to various advantageous features of the invention, considered separately or in combination:
the profile of the collar for housing the lens is defined to guide any droplet or trace of cleaning liquid that reaches it towards the emerging opening of the chamber, notably by having a rounded edge:
the suction means may be synchronized, which means to say operated simultaneously, with the means for spraying the cleaning liquid;
the optical sensor is coated with a layer of hydrophobic material so as to guide any droplet or trace of cleaning liquid present on the exterior surface of this optical sensor towards the emerging opening of the chamber.

The invention thus extends to an optical detection system, notably an image capture device, of which the optical sensor and of which the collar for housing this optical sensor in a casing that houses the optical detection system have the features that have just been described.

Other features, details and advantages of the invention and of the operation thereof will become more clearly apparent from reading the description given hereinafter by way of indication in conjunction with the attached figures in which:

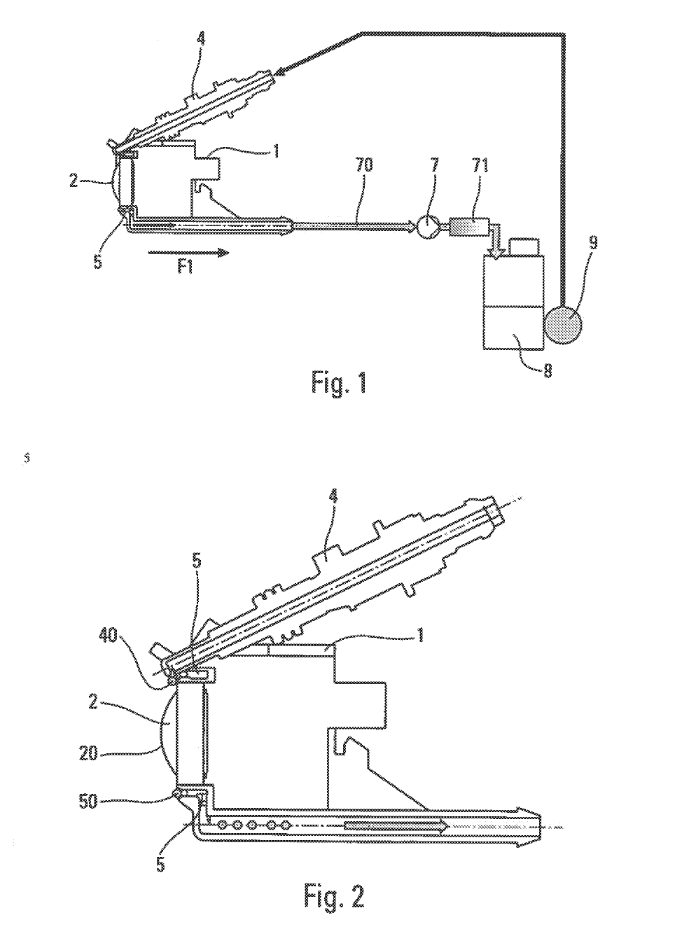

FIG. 1 is a schematic view in cross section of an optical detection system, notably an image capture apparatus, and of a device for cleaning an optical sensor, notably a lens, of this system according to the invention;

FIG. 2 is a view similar to that of FIG. 1, illustrating more clearly the lens and the elements of the cleaning device which are arranged around the lens;

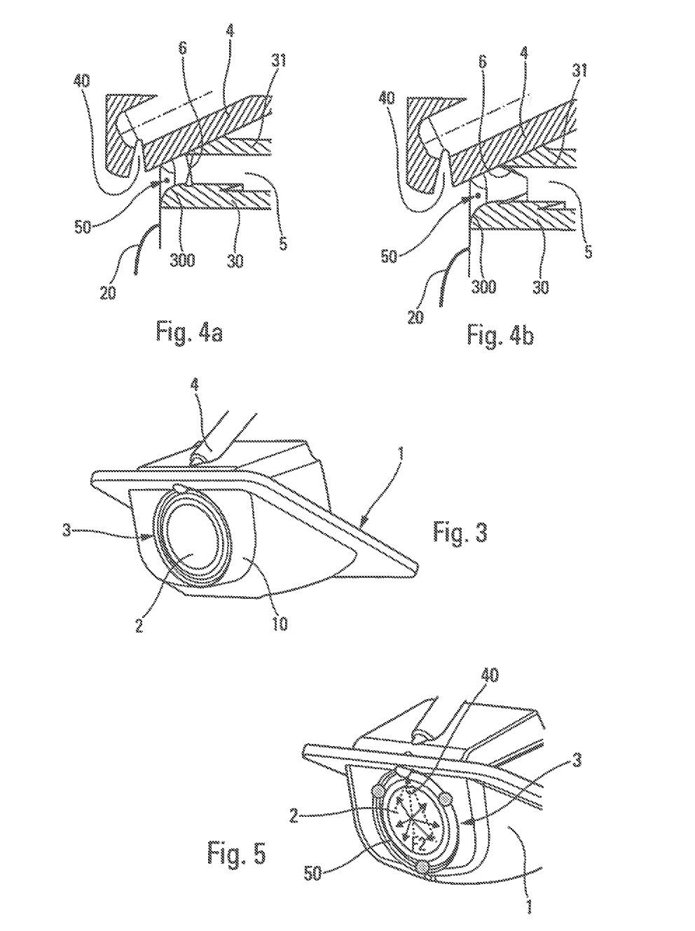

FIG. 3 is a schematic perspective overview of the cleaning device illustrated in FIG. 2, showing the casing that houses the camera and the associated lens;

FIG. 4a and FIG. 4b are detailed views in cross section schematically illustrating a chamber of the cleaning device, which chamber is arranged around the lens, and two states of an elastic sealing lip associated with this chamber, in a closed position (FIG. 4a) and an open position (FIG. 4b); and

FIG. 5 is a view similar to that of FIG. 3, which schematically illustrates the path of the cleaning liquid on the exterior surface of the lens of an image capture apparatus according to the invention.

In the descriptive part that is to follow, an optical detection system and the associated optical sensor are going to be defined more particularly via an image capture apparatus comprising a camera housed in a housing casing 1 such that an exterior surface 20 of its lens 2 lies flush slightly proud of an exterior face 10 of this casing. The lens 2, in this instance a convex lens with a circular edge, is placed in position on this exterior face 10 inside a substantially annular collar 3. The image capture apparatus is associated with a lens cleaning device comprising means for spraying a cleaning liquid onto the lens, these notably comprising a spray nozzle 4, and means for sucking up the sprayed liquid, notably comprising a chamber 5, a deformable elastic lip 6 that allows or prevents access from the outside, and a pump 7 arranged on a pipe connecting it to the chamber 5 to allow the latter to be evacuated and the liquid sucked up. The cleaning device further comprises a control module configured to command the operation of the cleaning means and of the means for sucking up the cleaning liquid used, this operation of the one and of the other being able to be simultaneous or deferred.

The collar 3 takes the form of an annular well which extends projecting from the exterior face 10 of the housing casing and an interior edge 30 of which becomes placed in contact with the exterior peripheral edge of the lens. Positioned in this way, the collar 3 both holds the lens and the camera relative to the casing 1 that houses the latter, and provides sealing between the exterior space and the inside of this housing casing. Advantageously made from a polymer material offering a certain elasticity, the collar 3 also acts as a shock absorber damping potential vibrations of the housing casing 1 or potential impacts therewith in order to avoid any shifting of the lens when capturing an image and is thus improve the stability of the images captured by the camera. The collar is hollowed in its thickness around the lens to create the chambers 5 capable of being evacuated by actuation of the pump 7.

The cleaning liquid is sprayed onto the exterior surface 20 of the lens 2 via a distribution orifice 40 arranged at one end of a distribution nozzle 4, the distribution orifice 40 being positioned close to the exterior surface 20 of the lens 2 so that the cleaning liquid reaches and spreads over a maximum of this exterior surface. According to various embodiments of such a cleaning device, the distribution nozzle 4 may be fixed relative to the exterior surface 20 of the lens 2 or may be capable of moving between a deployed position in which its distribution orifice 40 is close to the exterior surface 20 of the lens 2 and a retracted position, for example set back towards the inside of the casing 1, in which its distribution orifice is some distance away from the exterior surface 20 of the lens 2. Such a cleaning device further comprises conveying means 9 (depicted schematically in FIG. 1) for conveying a cleaning liquid from a storage reservoir 8 (schematically depicted in FIG. 1) as far as the distribution orifice 40.

The chamber 5 opens at an opening 50 onto at least a portion of the periphery of the lens 2. Advantageously, this chamber 5 is arranged within the collar 3 that houses the lens 2 in the casing 1, and opens onto the exterior face 10 of the casing substantially at the centre of this collar. According to the preferred embodiment of the invention as illustrated by the figures, the emerging opening 50 at which the chamber 5 opens to the exterior surface of the collar 3 is annular around the lens 2. More specifically, the annular opening 50 via which the chamber 5 opens onto the exterior face of the casing is placed between the interior edge 30 and the exterior edge 31 of this collar. Provision could be made for the chamber 5 to open at one or more openings 50 respectively occupying an angular portion of the perimeter of the collar 3. In the case of a single opening, the emergent opening 50 of the chamber 5 will advantageously be arranged in a region opposite, with respect to the centre of the lens 2, to the position of the cleaning liquid distribution orifice 40. In the case of a plurality of emergent openings, these will advantageously be evenly angularly distributed at the periphery of the lens 2.

The chamber 5 comprises an elastic sealing lip 6 capable of moving between a closed position, more particularly illustrated in FIG. 4a, and an open position, more particularly illustrated in FIG. 4b. In its open position, the elastic sealing lip 6 places the interior space of the chamber 5 in communication with the exterior space outside the casing 1. In this position, a liquid on the exterior surface 20 of the lens 2 may be conveyed towards the inside of the chamber 5 via the emergent opening 50 thereof at the surface of the collar 3. In the dosed position of the elastic sealing lip 6, the space external to the casing 1, and therefore the external surface of the lens, and the interior of the chamber 5 are separated in a sealed manner and the elastic sealing lip impedes the passage of the liquid on the exterior surface 20 of the lens 2. According to the preferred embodiment of the invention as illustrated by the figures, in which the chamber 5 opens at an annular opening 50 in the collar 3, the cleaning liquid distribution nozzle and the chamber 5 are advantageously arranged in such a way that the distribution orifice 40 is near this annular emergent opening 50 when it sprays cleaning liquid,

The cleaning liquid is sucked up by the pump 7 which is configured to be able to create a depression in the chamber 5. The chamber 5 is placed in communication with this pump 7 by a first pipe 70 forming part of a looped circuit of cleaning liquid, the said loop circuit comprising this first pipe 70, a second pipe 80 connecting the pump to the cleaning liquid storage reservoir and the conveying means 9. The depression created in the chamber 5 is engineered to deform the elastic sealing lip 6 and force it into the open position, allowing the cleaning liquid to pass from the outside of the casing 1 to the inside. When the pump 7 is switched off and equilibrium is established, the elastic sealing lip 6 naturally returns to its original position, namely the closed position in which it impedes the ingress of liquid and dirt into the chamber.

In the embodiment illustrated the elastic sealing lip 6 is formed of two parts 6a, 6b, one of which is secured at one of its ends to the interior edge 30 of the collar and the other of which is secured at one of its ends to the exterior edge 31 of the collar (visible in FIGS. 4a and 4b). In the rest position, namely in the dosed position (visible in FIG. 4a), the two parts of the lip extend substantially at right angles to the walls to which they are respectively fixed, overlapping at their free end inside the chamber, so as to block the passage towards the inside. When o the depression is created inside the chamber 5, using the pump 7, the two parts 6a, 6b of the lip are sucked towards the pump and therefore towards the bottom of the chamber 5, away from the emergent opening 50, thereby uncovering a path between the free ends of the two parts. It will be appreciated that this embodiment of the sealing lip is given solely by way of example and that this lip could comprise just one part, in which case it is secured at one of its ends to one of the edges of the collar and the free end is able to retract towards the bottom of the chamber as soon as the pump 7 is actuated.

The operation of the device will now be described according to various embodiments of the invention in which the opening or closing of the elastic sealing lip 6 is or is not synchronized with the distribution of cleaning liquid by the distribution orifice 40.

In a first embodiment in which the opening of the elastic seating lip 6 is not synchronized with the distribution of cleaning liquid, provision is made, in a first step, while the elastic sealing lip 6 is in its closed position, for a cleaning liquid to be sprayed onto the exterior surface 20 of the lens 2 by the distribution orifice 40. The cleaning liquid spreads over the exterior surface 20 of the lens 2 for a predefined length of time before the control module generates an instruction to open this elastic sealing lip by switching on the pump 7. The result then is that a depression is created in the chamber 5, drawing the elastic lip into the open position, and the result of this depression is that there is a suction through the emergent opening 50 towards the inside of the chamber 5. The cleaning liquid resting on the lens or on the collar is thus guided by suction towards the chamber 5, from which it is conveyed, in a direction illustrated by the arrow F1 in FIG. 1, as far as the pump 7. According to the embodiment more particularly illustrated in FIG. 1, the cleaning liquid is then conveyed through a filtering assembly 71 and is then returned to the storage reservoir 8 where it is recycled for a later cleaning operation.

In order to encourage the passage of cleaning liquid at the surface of the lens 2 towards the chamber, the invention also makes provision for the exterior surface 20 of this lens to be covered with a layer of a hydrophobic material. Thus, and as the arrows F2 in FIG. 6 show, once the cleaning liquid has been sprayed onto the exterior surface 20 of the lens 2, it will be physically repelled towards the edges of the lens 2, namely towards the collar 3 and towards the emergent opening 50. In addition, in order to encourage the transfer of cleaning liquid to the chamber 5, the invention makes provision for at least the interior edge of the collar 3 to have, in cross section, a rounded profile 300 visible in FIGS. 4a and 4b. Thus, any droplet of cleaning liquid that reaches the interior edge of the collar 3 will be guided, by this rounded profile 300, towards the emergent opening 50 and, from there, towards the chamber 5.

In an alternative embodiment of the invention, the distribution of cleaning liquid may be synchronized, which is to say simultaneous, with the opening of the elastic sealing lip 6. in that case, the suction through the opening of the emergent chamber 50 contributes to the spreading of the cleaning liquid over the exterior surface 20 of the lens 2, especially if this emergent opening 50 extends annularly around the lens 2, as illustrated in the figures. Such an embodiment thus makes it possible to reduce the duration of the lens-cleaning cycle since the suction by the chamber 5 then leads to a form of forced circulation of cleaning liquid over the exterior surface 20 of the lens 2, which forced circulation is strengthened by the existence of the curvature of the lens and by the potential presence, on the exterior surface thereof, of the aforementioned hydrophobic coating. It will be appreciated that the presence of a hydrophobic coating in this embodiment is not as necessary as it was in the preceding case.

As has just been described in each of its embodiments, the present invention makes it possible to put in place a means of removing a cleaning liquid previously sprayed over a camera lens, which is particularly simple to put in place, which is internal to the casing housing the camera end therefore not sensitive to external conditions, and which may furthermore contribute to a closed-loop circuit that allows the cleaning liquid to be recycled.

The invention should not however be restricted to the means and configurations described and illustrated, but also applies to any equivalent means or configurations and to any combination of such means. In particular, it applies to any form and any type of optical detection system and associated optical sensor. Likewise, it applies to any method of distributing a cleaning liquid to the surface of such an optical sensor in order to dean it (mobile nozzle, simple or multiple nozzle, etc).

1. A device for cleaning an optical sensor of an optical detection system of a motor vehicle, the device comprising:
spray means for spraying a cleaning liquid onto an exterior surface of the optical sensor; and
suction means having a chamber that opens onto at least a portion of the periphery of the optical sensor.

2. The device according to claim 1, wherein the chamber opens onto a portion of the periphery of the optical sensor opposite to the region from which the cleaning liquid is sprayed onto the exterior surface of the optical sensor.

3. The device according to claim 1, wherein the chamber opens onto the entire periphery of the optical sensor.

4. The device according to claim 1, wherein the optical sensor is mounted in a casing that houses the optical detection system associated with the optical sensor, being fitted tightly inside a collar defined on a wall of the casing, the chamber being hollowed into the thickness of the collar.

5. The device according to claim 4, wherein an emergent opening of the chamber is arranged between an interior edge of the collar configured to be placed in contact with the exterior peripheral edge of the optical sensor, and an exterior edge of the collar.

6. The device according to claim 1, wherein the chamber comprises an elastic sealing lip able to move between a closed position in which the sealing lip prevents any passage of liquid between the exterior surface of the optical sensor and the inside of the chamber, and an open position in which the sealing lip allows the passage of liquid from the exterior surface of the optical sensor towards the inside of the chamber.

7. The device according to claim 6, wherein the elastic sealing lip moves from the open position to the closed position under the effect of the actuation of the suction means for evacuating the chamber.

8. The device according to claim 7, wherein the suction means are configured to discharge the sucked-up liquid into a storage reservoir for supplying the means of spraying the optical sensor with cleaning liquid.

9. The device according to claim 1, wherein the suction means are synchronized with means for commanding the distribution of liquid.

10. An optical detection system for a motor vehicle comprising:
at least one device for cleaning an optical sensor of the system according to claim 1,
wherein the exterior surface of the optical sensor is covered with a layer of a hydrophobic material.
